(19) United States
(12) Patent Application Publication
(10) Pub. No.: US 2016/0352762 A1
(43) Pub. Date: Dec. 1, 2016

(54) Probabilistically Detecting Low Intensity Threat Events

(71) Applicant: INTERNATIONAL BUSINESS MACHINES CORPORATION, ARMONK, NY (US)

(72) Inventors: Robert R. Friedlander, Southbury, CT (US); James R. Kraemer, Santa Fe, NM (US); Jeb R. Linton, Manassas, VA (US); Christopher M. Poulin, Walpole, MA (US)

(21) Appl. No.: 14/721,091

(22) Filed: May 26, 2015

(51) Int. Cl. H04L 29/06

(52) U.S. Cl. CPC H04L 63/1425; H04L 63/1466

(57) ABSTRACT

A method, system, and/or computer program product probabilistically detects a low intensity threat event against an attack surface. A notification of disparate anomalies experienced by each of multiple attack surfaces is received. The disparate anomalies occur over an extended period of time that exceeds a maximum threshold time period required to identify a high intensity attack against one or more of the multiple attack surfaces. A synthetic event that includes all of the disparate anomalies experienced by the multiple attack surfaces is generated. In response to receiving a notification that the at least one particular attack surface is experiencing a predefined quantity of the disparate anomalies found in the synthetic event, an alert that a malicious attack is being attempted against one or more attack surfaces is generated.

### BACKGROUND

The present disclosure relates to the field of computers, and specifically to the field of computers that are accessible via networks. Still more specifically, the present disclosure relates to the field of detecting malicious attacks on computers that are accessible via networks.

### SUMMARY

A method, system, and/or computer program product probabilistically detects a low intensity threat event against an attack surface. A notification of disparate anomalies experienced by each of multiple attack surfaces is received. The disparate anomalies occur over an extended period of time that exceeds a maximum threshold time period required to identify a high intensity attack against one or more of the multiple attack surfaces. A synthetic event that includes all of the disparate anomalies experienced by the multiple attack surfaces is generated. In response to receiving a notification that the at least one particular attack surface is experiencing a predefined quantity of the disparate anomalies found in the synthetic event, an alert that a malicious attack is being attempted against one or more attack surfaces is generated.

### BRIEF DESCRIPTION OF THE DRAWINGS

FIG. 1 depicts an exemplary system and network in which the present disclosure may be implemented;

FIG. 2 illustrates an exemplary process for creating a synthetic event that describes multiple attack types;

FIG. 3 is a high-level flowchart of one or more steps performed by one or more processors to probabilistically detect low intensity threat events;

FIG. 4 depicts a cloud computing node according to an embodiment of the present disclosure;

FIG. 5 depicts a cloud computing environment according to an embodiment of the present disclosure; and

FIG. 6 depicts abstraction model layers according to an embodiment of the present disclosure.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

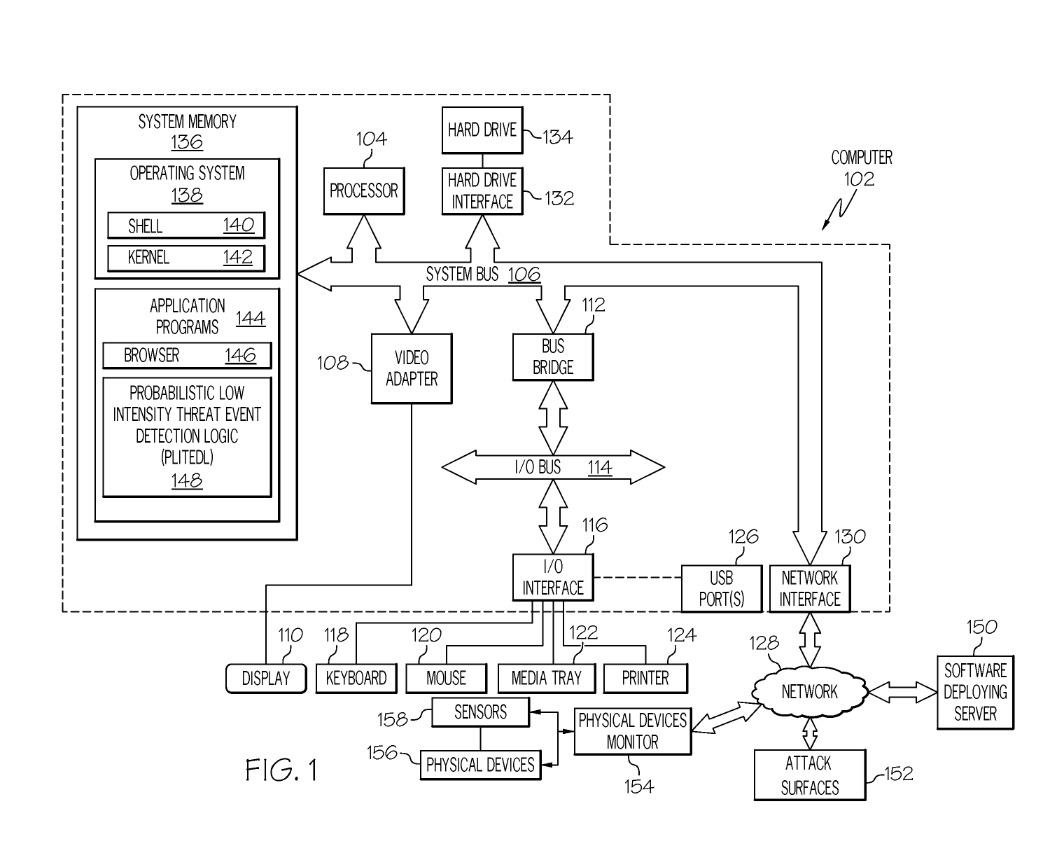

With reference now to the figures, and in particular to FIG. 1, there is depicted a block diagram of an exemplary system and network that may be utilized by and/or in the implementation of the present invention. Some or all of the exemplary architecture, including both depicted hardware and software shown for and within computer 102, may be utilized by software deploying server 150 and/or attack surfaces 152 and/or physical devices monitor 154 and/or physical devices 156.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or attack surfaces 152 and/or a physical devices monitor 154 using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

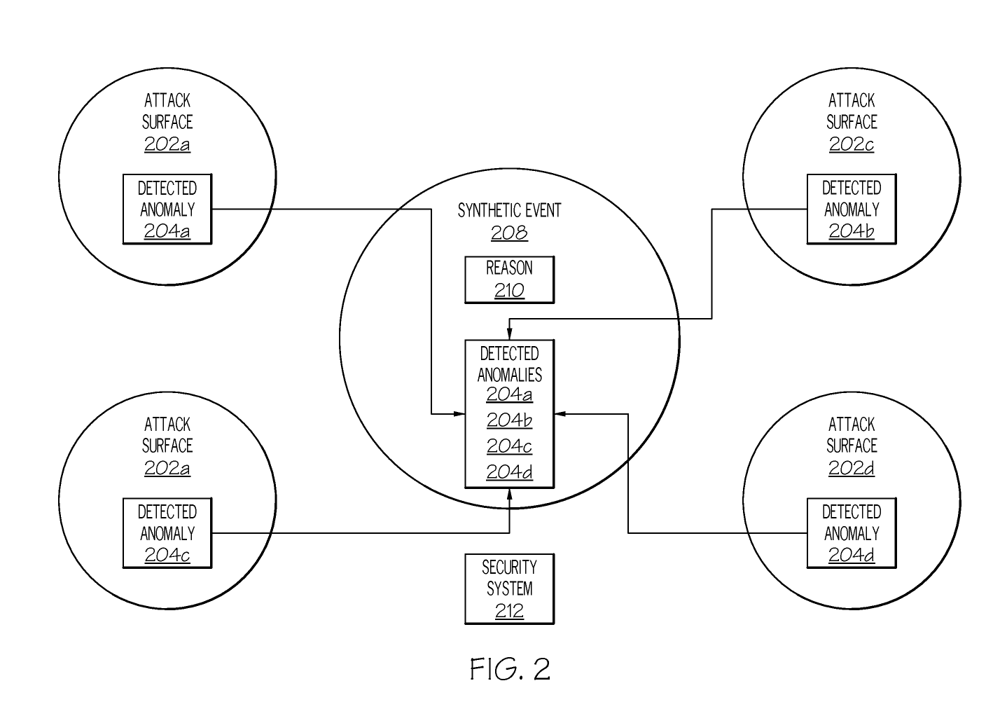

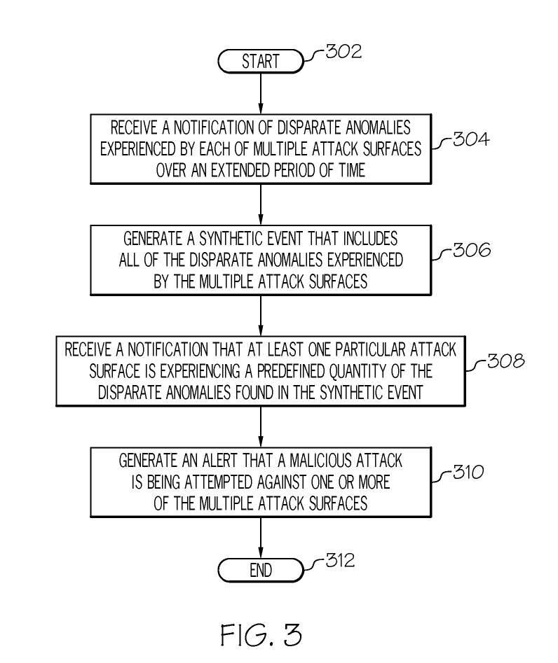

Application programs 144 in computer 102's system memory (as well as software deploying server 150's system memory) also include Probabilistic Low Intensity Threat Event Detection Logic (PLITEDL) 148. PLITEDL 148 includes code for implementing the processes described below, including those described in FIGS. 2-3. In one embodiment, computer 102 is able to download PLITEDL 148 from software deploying server 150, including in an on-demand basis, wherein the code in PLITEDL 148 is not downloaded until needed for execution. In one embodiment of the present invention, software deploying server 150 performs all of the functions associated with the present invention (including execution of PLITEDL 148), thus freeing computer 102 from having to use its own internal computing resources to execute PLITEDL 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

The present invention is directed to identifying low intensity cyber attacks.

A cyber attack is defined as an electronic attack against computers, computer networks, software, data storage devices, and/or non-computing devices in order to steal, alter, or destroy a set of data, and/or to alter the operations of a computing and/or non-computing device. Such cyber attacks are performed by remotely accessing such resources via nefarious means known as “hacking”, which is accessing a computer and/or computer resource and/or non-computing devices by unauthorized means.

For example, a cyber attack may be directed to a database of sensitive information, such as a listing of credit card numbers, social security numbers, banking information, etc. This type of cyber attack is designed to alter or steal such information (e.g., to be used for “identity theft” of private information for various persons).

In another example, the cyber attack may be against a particular device, which may be a computing device/resource or a non-computing device/resource. Examples of a computing device/resource include but are not limited to a computer, a server, a data storage device, a computer network, software, firmware, etc. Examples of a non-computing device/resource include but are not limited to equipment such as a power generator, a pump, a power distribution line, a feedstock line in a refinery, etc.

One category of cyber attack is known as a “high intensity attack”. A high intensity attack uses multiple attacks against a single resource at a high rate, or uses a single type of attack against multiple resources at a high rate. High intensity attacks may be designed to penetrate a resource's security, or it may simply be designed to overwhelm the resource.

Thus, one type of high intensity attack uses many variations of an attack against a single resource. For example, a hacker may try using many different types of code (e.g., malware) in an attempt to access a particular server. By using many different types of malware in the attempt, the hacker's chances of using a piece of malware that is successful in penetrating that single resource's security is greatly increased.

Another type of high intensity attack uses many repetitions of a single type of attack against a system, such that the hacker does not care whether or not a protected resource is accessed, but rather that the system itself is simply overloaded. A Distributed Denial of Service (DDoS) is one example of this type of high intensity attack. An exemplary DDoS attack requests and/or consumes computer resources at such a high rate that other legitimate users are unable to access these overloaded computer resources. That is, a DDoS may cause the system being attacked to spend most or all of its computing power simply responding to the DDoS attack, thus denying legitimate users the use of the system's resources. This computing power may be devoted to running the system's security (e.g., firewall), or it may be responding to and providing access to the system's resources. For example, a DDoS may request resources that are freely available to the public (e.g., an enterprise's website). However, by one party requesting this website at an extremely high rate, the web server becomes overloaded, thus preventing legitimate users from having access to the web server/website.

Another type of high intensity attack uses a same malicious attack against multiple computer resources. In this type of attack, no individual resource is overloaded. However, by attacking many computer resources with a same type of attack, the chance of successfully accessing/attacking one or more of the resources is increased. For example, attempts to log onto thousands of servers may be performed using a same password (e.g., a common password such as “Guest”). While this password is unlikely to work on most of the servers, it is likely to work on at least a few of the servers.

All types of high intensity attacks are typically easy to identify, since they show up as a severe uptick in activity. That is, if a web server shows a 10,000-fold increase in requests for a webpage (i.e., a DDoS attack), this increase is easy to identify. Stated another way, the nefarious activity (e.g., millions of requests for a webpage within a few minutes) can be considered the “signal” that something amiss is occurring. Nominal operations (e.g., a normal volume of requests for the webpage) can be considered “noise” that represents normal operations, including erroneous operations. For example and with respect to web server operations, “noise” includes legitimate and successful accesses to webpages from a web server, as well as legitimate but unsuccessful (e.g., due to typographical errors in requesting a particular web page, providing a password, etc.) attempts to access the webpages. In a manner analogous to audio electronics, the signal-to-noise ratio of a high intensity attack is high.

Thus, a DDoS attack is nearly all “signal” (very high volume of nefarious attacks) compared to the relatively low number of legitimate requests to access the resource (“noise”), thus giving a DDoS attack a very high signal-to-noise ratio.

Similarly, a high intensity attack that uses a same type of attack against different resources (e.g., sending a same piece of malware to multiple servers) also has a high signal-to-noise ratio, since the “signal” (using many copies of the same malware) is much higher than the background “noise” (handling normal traffic/requests).

While a high intensity attack is easy to detect (due to the high number of similar attacks), a low intensity attack is much more difficult to detect.

A low intensity attack is defined as a malicious attack against one or more resources over an extended period of time. This extended period of time exceeds that used in a high intensity attack. That is, a high intensity attack is identified by the fact that it has many attacks over a short period of time. In the case of a DDoS attack, the period of time may be a few seconds. In the case of a DDoS attack against various resources, the same malware is deployed against the various resources within a short amount of time (e.g., within a few minutes).

Thus, in a low intensity attack, malware is deployed at a rate that is so slow, normal security systems treat them as “normal” activities. That is, a normal security system will recognize a message that contains a known piece of malware, an incorrect password, an improper type of request (e.g., requesting a video file from a bookkeeping program), etc., and will take steps to block that message. Since such erroneous messages occur with great frequency due to simple mistakes (e.g., typographical errors, lack of understanding about what a server can and cannot provide, etc.), these erroneous messages will not raise any alarms, since raising an alarm every time a user makes a typographical error would dilute the warning system such that it becomes meaningless.

Thus, low intensity attacks are very difficult to detect, even after they are successful. That is, by patiently (e.g., over the course of a year) attempting to access one or more resources using malware, fake passwords, etc., eventually the hacker may access a resource, all without raising any alarms.

The problem of recognizing low intensity attacks is made even more difficult if different types of attacks are attempted on multiple resources. For example, one server may be attacked by providing a fake password, while another server may be attacked with a virus, while another server may be attacked by changing its IP address.

The problem becomes even more difficult if the attacks are against different types of resources (also called “attack surfaces”). For example, a storage device may be attacked to change data stored therein, a server may be attacked to change its IP port, and an industrial pump may be attacked such that it is turned on at an inopportune time.

The present invention provides a new and useful approach to probabilistically recognizing such low intensity attacks that use different cyber attacks against multiple resources, which may be similar types of resources or disparate types of resources.

With reference now to FIG. 2, an exemplary process for creating a synthetic event used to probabilistically determine that an attack event is occurring is presented.

As shown in FIG. 2, multiple attack surfaces 202a-202d have experienced respective detected anomalies 204a-204d. The attack surfaces 202a-202d are defined as resources that are subject to a cyber attack. Examples of attack surfaces 202a-202d include, but are not limited to, personal computers, tablet computers, servers, smart phones, computer networks, mechanical equipment, and/or firmware/software (e.g., application programs, e-mail system, operating systems, basic input output systems—BIOS, etc.).

As shown in FIG. 2, a synthetic event 208 is created by combining the multiple detected anomalies 204a-204d into a single object, which is the synthetic event 208 itself.

In one embodiment of the present invention, the attack surfaces 202a-202d are similar types of resources. For example, assume that attack surfaces 202a-202d are all servers. However, detected anomaly 204a is an attempt to change an Internet Protocol (IP) address for the server that is represented by attack surface 202a, detected anomaly 204b is an attempt to access the server that is represented by attack surface 202b by using an incorrect password, detected anomaly 204c is an attempt to take offline (i.e., disconnect from a network) the server that is represented by attack surface 202c, and detected anomaly 204d is an attempt to extract protected data stored within the server that is represented by attack surface 202d.

The detected anomalies 204a-204d may have been thwarted by security systems (e.g., security system 212 shown in FIG. 2, which may be implemented as computer 102 shown in FIG. 1) associated with the servers that are represented by the attack surfaces 202a-202d. However, these security systems did not raise any alarms, since such anomalies are common. Nonetheless, it is the disparity among the detected anomalies 204a-204d that is used by one or more embodiments of the present invention to raise an alarm that the detected anomalies 204a-204d are part of a family/cohort of nefarious attacks, particularly due to the low frequency of the detected anomalies 204a-204d (i.e., they are not “high intensity attacks” that by definition occur within a short time period).

As shown in FIG. 2, associated with the synthetic event 208 is a reason 210, which describes what prompted the security systems to prevent the attempted misuses (i.e., what prompted the security systems associated with the attack surfaces 202a-202d to block the detected anomalies 204a-204d), and/or why the detected anomalies 204a-204d were combined together to create the synthetic event 208.

With regard to the reason for combining the detected anomalies 204a-204d to create the synthetic event 208, various rules may control the decision to combine such detected anomalies 204a-204d.

In one embodiment of the present invention, the decision to combine the detected anomalies 204a-204d to create the synthetic event 208 may be based on the detected anomalies 204a-204d being different types of attacks, but which are applied to a same type of attack surface (from attack surfaces 202a-202d), again over an extended period of time that is beyond the period of time indicative of a high intensity attack. For example, various types of malware (detected anomalies 204a-204d) may be used against a multiple servers (attack surfaces 202a-202d), but all of the servers are the same type of server (e.g., they are all webpage servers). Since these attacks are so “spread out” over time, the security system 212 never raised any alarms, since it treated the detected anomalies 204a-240d as mere operational “noise”, rather than being indicative of a high intensity attack. However, it is due to the fact that the similar types of attacks were spread out across similar resources over a long period of time that the present invention deems them suspicious, since they may have been designed to evade high intensity attacks.

In one embodiment of the present invention, the decision to combine the detected anomalies 204a-204d to create the synthetic event 208 may be based on the detected anomalies 204a-204d being different types of attacks that are applied to different types of attack surfaces (from attack surfaces 202a-202d), again over an extended period of time that is beyond the period of time indicative of a high intensity attack. For example, the types of attacks (detected anomalies 204a-204d) may be different types (“fishing”, Trojan horses, DDoS attacks, etc.), and the types or resources being attacked (attack surfaces 202a-202d) are also different (different types of servers, storage devices, software, etc.). Again, these types of attacks are designed to avoid detection by high intensity attack detectors, which is what makes them suspicious in accordance with one or more embodiments of the present invention.

Thus, in one embodiment of the present invention, the decision to combine the detected anomalies 204a-204d to create the synthetic event 208 is based on 1) the disparate nature of the detected anomalies 204a-204d, and 2) the fact that the detected anomalies 204a-204d occurred at the various attack surfaces 202a-202d over a longer (predefined) period of time than that required by a high intensity attack.

With regard now to FIG. 3, a high-level flowchart of one or more steps performed by one or more processors to probabilistically detect low intensity threat events to attack surfaces is presented.

After initiator block 302, a notification of disparate anomalies (e.g., detected anomalies 204a-204d shown in FIG. 2) experienced by each of multiple attack surfaces (e.g., attack surfaces 202a-202d shown in FIG. 2) over an extended period of time is received (block 304). The disparate anomalies are different types of anomalies compared to one another, as described herein.

Examples of disparate anomalies include, but are not limited to the following types of anomalies.

For example, a system may receive a structured query language (SQL) request for data from relational database. However, the system that receives the SQL request is actually a webpage server, and thus the SQL request makes no sense, since the webpage server serves up webpages, and does not handle relational databases. Thus, the SQL request to the webpage server for relational database data is an anomaly for the webpage server.

In another example, a database server may receive a request for a set of privileged data, which the requester does not have the authority to access (e.g., does not know the password needed to access the privileged data). Thus, this request is an anomaly for the database server.

In another example, a database server may receive a request for specific data that the database server simply does not have. Thus, this request is an anomaly for the database server.

In another example, a computer may receive a string of data that is addressed to an application that is running on the computer. However, this application processes strings of data that are only of a particular length. If the received string of data is longer than this particular length, then there is a possibility/likelihood that the extra data in the string is actually malware. Thus, receipt of this string of data that is too long for the application is an anomaly for this computer/application.

In another example, a computer may receive an incorrect password needed to access a database, a webpage, a program, etc. Thus, receipt of this incorrect password is an anomaly for this computer.

In another example, a computer and/or application may have rules regarding when it can be accessed (e.g., only between 0900 and 1700 Monday through Friday). If an access to the computer and/or application occurs outside of this time frame (e.g., on Saturday at midnight), then this access is an anomaly for this computer and/or application.

The extended period during which the disparate anomalies occur may exceed a maximum threshold time period required to identify a high intensity attack against one or more of the multiple attack surfaces. For example, assume that in order for an event to be recognized as a high intensity attack (or any type of attack) by a security system (e.g., security system 212 in FIG. 2), a predefined quantity of events (disparate anomalies) must occur within one hour or less. If this quantity of disparate anomalies occur over a time period that is longer than one hour (or week or month or year, depending on what time period has been deemed appropriate for a high intensity attack), then they do not cause the security system to initially raise an alarm, even though the security system may have determined that the event is in fact an anomaly (although not necessarily a malicious attack).

Returning to FIG. 3, a synthetic event (e.g., synthetic event 208 in FIG. 2) that includes all of the disparate anomalies experienced by the multiple attack surfaces is generated (block 306).

As described in block 308, a notification that at least one particular attack surface is experiencing a predefined quantity of the disparate anomalies found in the synthetic event is received. That is, after the synthetic event 208 is created, one or more of the disparate anomalies found in the synthetic event 208 occurs on an attack surface (which may or may not be one of the attack surfaces 202a-202d shown in FIG. 2 to generate the synthetic event 208). If so, then an alert that a malicious attack is being attempted against one or more of the multiple attack surfaces is generated (block 310).

The flow-chart ends at terminator block 312.

In one embodiment of the present invention, the disparate anomalies are collected from disparate physical locations. That is, disparate anomalies may be collected from the same or different types of resources at different geographical locations. In response to the collected disparate anomalies from the disparate physical locations exceeding a predetermined level, the synthetic event is generated. Thus, in this embodiment, the synthetic event is generated only if the combined (and yet disparate) anomalies occurring at different resources in different locations exceed some predefined level.

In one embodiment of the present invention, the predefined quantity of the disparate anomalies from the synthetic event that are experienced by another attack surface is one. That is, once the synthetic event is constructed using the detected anomalies 204a-204d shown in FIG. 2, then if one of the attack surfaces 202a-202d (or any other resource/attack surface) experiences just one of those detected anomalies 204a-204d, then that resource/attack surface is warned that it might be under attack. In another embodiment, however, more than one of the detected anomalies 204a-204d from the synthetic event 208 must be experienced by the subsequent resource/attack surface in order to warrant such a warning/alarm.

In one embodiment of the present invention, a notification is received stating that at least one of the anomalies found in the synthetic event resulted in a successful malicious attack against a certain attack surface. In response to receiving this notification, a warning is issued stating that all of the disparate anomalies found in the synthetic event are suspected malicious attacks. That is, the synthetic event 208 was initially constructed of detected anomalies 204a-204d, which were merely suspected of being malicious. This suspicion may be raised according to the disparate nature of the attacks/anomalies as described herein, or they may be raised according to cognitive analysis of past events (e.g., 90% of occurrences of certain types of anomalies eventually are confirmed as being malicious attacks/events). However, once one of the detected anomalies 204a-204d is confirmed as being malicious, then all of the detected anomalies 204a-204d are presumed to be malicious.

Similarly, if at least one of the detected anomalies found in the synthetic event contains a known malicious feature, then a warning is issued stating that all of the disparate anomalies found in the synthetic event are suspected malicious attacks. For example, assume that a detected anomaly is a message from an IP address that has a history of being used by a known hacker, or the message contains known malware code, then all of the detected anomalies 204a-204d that are used to construct the synthetic event 208 are deemed to be malicious.

In one embodiment of the present invention, the at least one particular attack surface that is later determined to be under attack (by having an anomaly found in the synthetic event) is only one attack surface from a group consisting of an application program, an operating system, a hardware-based storage device, and a hardware-based computing device. In another embodiment, however, the at least one particular attack surface is two or more attack surfaces from this group.

In one embodiment of the present invention, the disparate anomalies occur at different physical locations during the extended period of time, as described herein.

In one embodiment of the present invention, all of the disparate anomalies that were detected on the attack surfaces were attempted misuses of the multiple attack surfaces, and all of the attempted misuses were prevented by security systems on the multiple attack surfaces. In a further extension of this embodiment, an explanation (e.g., reason 210 in FIG. 2) is appended to the synthetic event describing what prompted the security systems to prevent the attempted misuses. For example, assume that detected anomaly 204a was an incorrect password and detected anomaly 204b was a message from an invalid IP address. Reason 210 in FIG. 2 would include a statement indicating that these were the reasons for the security system 212 determining (and thus detecting) that these events were anomalous.

In one embodiment of the present invention, one or more of the attack surfaces are cloud-based resources that reside on a cloud of remote servers and software networks that provided distributed computing capabilities to a user. Such resources may be physical (e.g., a physical server) or virtual (e.g., a virtual machine hosted on a cloud that emulates a physical computer).

In one embodiment of the present invention, the attack surface is a physical device, which may be a computing device or a non-computing device. In this embodiment, an anomaly signal is received from a sensor associated with the physical device. The anomaly signal from the sensor indicates an operational anomaly to the physical device. In response to receiving the anomaly signal from the sensor associated with the physical device, an attack signal indicating that the physical device is being maliciously attacked is generated.

For example, assume that the hardware sensor (e.g., one of the sensors 158 shown in FIG. 1) is a physical sensor on a unit of equipment, such as a computer, a pump, a generator, a vehicle, a train, an aircraft, etc. (e.g., physical devices 156 in FIG. 1). The physical devices 156 and/or sensors 158 may be directly monitored by a monitoring system such as computer 102 shown in FIG. 1, or they may be monitored by an intermediary physical devices monitor 154 (e.g., a monitoring computer). Using the example of a pump, assume that the hardware sensor is a flow meter that detects that the pump has increased its output tenfold (a detected anomaly). This detected anomaly sensed by the sensor, combined with the detected anomalies 204a-204d that resulted from anomalous messages to the physical devices monitor 154 and/or physical devices 156, indicates that a malicious activity is occurring against the physical device.

In another example, assume that the hardware sensor is from a set of chemical sensors that can detect airborne chemicals and/or airborne odor causing elements, molecules, gases, compounds, and/or combinations of molecules, elements, gases, and/or compounds in an air sample, such as, without limitation, an airborne chemical sensor, a gas detector, and/or an electronic nose. In one embodiment, such a set of chemical sensors is implemented as an array of electronic olfactory sensors and a pattern recognition system that detects and recognizes odors and identifies olfactory patterns associated with different odor causing particles. The array of electronic olfactory sensors may include, without limitation, metal oxide semiconductors (MOS), conducting polymers (CP), quartz crystal microbalance, surface acoustic wave (SAW), and field effect transistors (MOSFET). The particles detected by set of chemical sensors may include, without limitation, atoms, molecules, elements, gases, compounds, or any type of airborne odor causing matter. In this example, assume that the chemical sensors detect the new presence of a hazardous chemical in an environment being controlled by one of the physical devices 156 shown in FIG. 1 (e.g., ventilation fans). Combining these detection signals from the sensor 158 with the detected anomalies 204a-204d that resulted from anomalous messages to the physical devices monitor 154 and/or physical devices 156 indicates that a malicious activity is occurring against the physical device (e.g., the fans have been turned off).

In the case of a computing device, the sensors 158 may be any type of on-board sensor, such as a thermometer, a CPU execution rate sensor, a port sensor that detects network traffic rate, etc. that tracks internal operations of a computer. If these sensors 158 detect an anomaly, beyond the detected anomalies 204a-204d (e.g., a hacking attempt), then this combination of factors leads to the conclusion that this computer is under attack.

The present invention may be implemented using cloud computing, as now described. Nonetheless, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

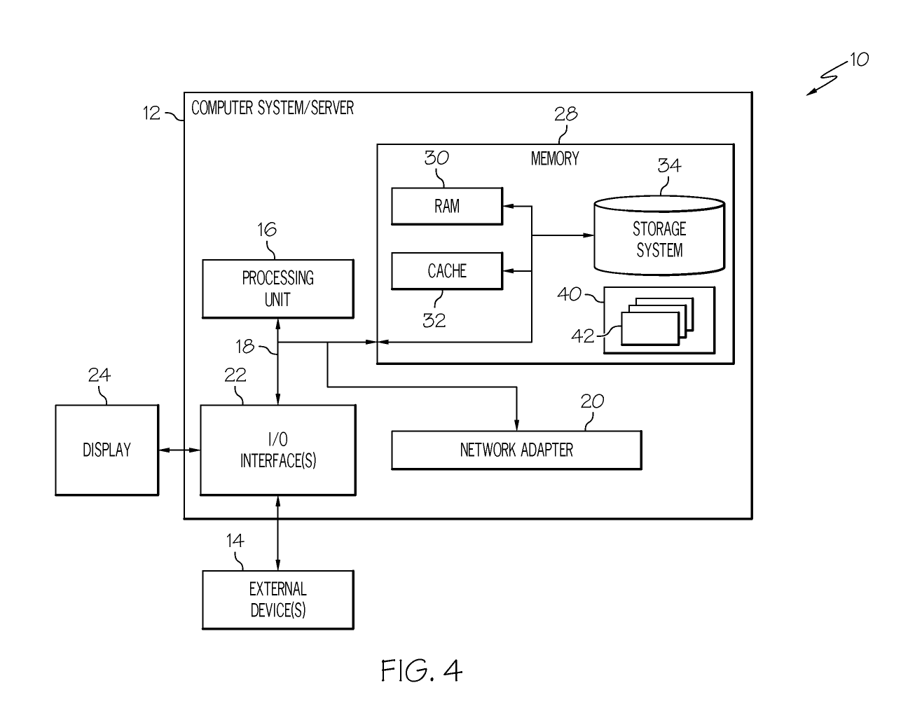

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

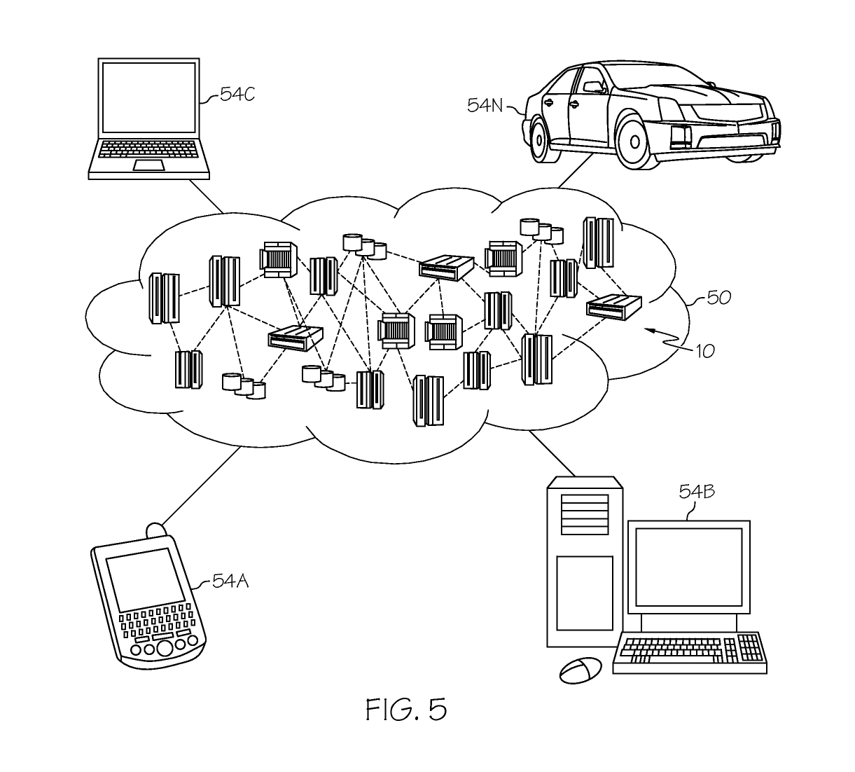

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices MA-N shown in FIG. 5 are intended to be illustrative only and that computing nodes 10 and cloud computing environment 50 can communicate with any type of computerized device over any type of network and/or network addressable connection (e.g., using a web browser).

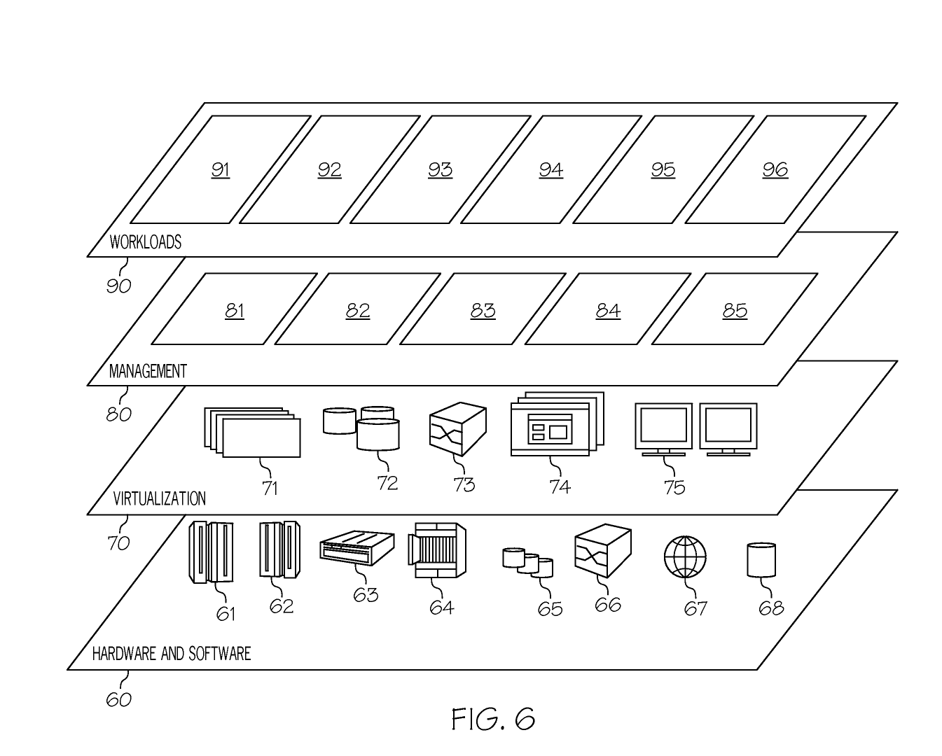

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and probabilistic detection of low intensity threat event processing 96 (for probabilistically detecting low intensity attack events as described herein).

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method of probabilistically detecting a low intensity threat event to an attack surface, the method comprising:
receiving, by one or more processors, a notification of disparate anomalies experienced by each of multiple attack surfaces over an extended period of time, wherein the disparate anomalies are different types of anomalies compared to one another, and wherein the extended period of time exceeds a maximum threshold time period required to identify a high intensity attack against one or more of the multiple attack surfaces;
generating, by one or more processors, a synthetic event that includes all of the disparate anomalies experienced by the multiple attack surfaces;
receiving, by one or more processors, a notification that at least one particular attack surface is experiencing a predefined quantity of the disparate anomalies found in the synthetic event; and
in response to receiving the notification that the at least one particular attack surface is experiencing the predefined quantity of the disparate anomalies found in the synthetic event, generating, by one or more processors, an alert that a malicious attack is being attempted against one or more of the multiple attack surfaces.

2. The method of claim 1, further comprising:
collecting the disparate anomalies from disparate physical locations; and
in response to the collected disparate anomalies from the disparate physical locations exceeding a predetermined level, generating the synthetic event.

3. The method of claim 1, wherein the predefined quantity of the disparate anomalies is one.

4. The method of claim 1, wherein the predefined quantity of the disparate anomalies is a multiple number.

5. The method of claim 1, further comprising:
receiving, by one or more processors, a notification that at least one of the disparate anomalies found in the synthetic event resulted in a successful malicious attack against a certain attack surface; and
in response to receiving the notification that at least one of the disparate anomalies found in the synthetic event resulted in the successful malicious attack against the certain attack surface, issuing, by one or more processors, a warning that all of the disparate anomalies found in the synthetic event are suspected malicious attacks.

6. The method of claim 1, further comprising:
receiving, by one or more processors, a notification that at least one of the disparate anomalies found in the synthetic event contains a known malicious feature; and
in response to receiving the notification that at least one of the disparate anomalies found in the synthetic event contains the known malicious feature, issuing, by one or more processors, a warning that all of the disparate anomalies found in the synthetic event are suspected malicious attacks.

7. The method of claim 1, wherein the at least one particular attack surface is only one attack surface from a group consisting of an application program, an operating system, a hardware-based storage device, and a hardware-based computing device.

8. The method of claim 1, wherein the at least one particular attack surface is two or more attack surfaces from a group consisting of an application program, an operating system, a hardware-based storage device, and a hardware-based computing device.

9. The method of claim 1, wherein the disparate anomalies occurred at different physical locations during the extended period of time.

10. The method of claim 1, wherein all of the disparate anomalies were attempted misuses of the multiple attack surfaces, and wherein all of the attempted misuses were prevented by security systems on the multiple attack surfaces, and wherein the method further comprises:
appending, by one or more processors, an explanation to the synthetic event describing what prompted the security systems to prevent the attempted misuses.

11. The method of claim 1, wherein one or more of the attack surfaces are cloud-based resources.

12. The method of claim 1, wherein the attack surface is a physical device, and wherein the method further comprises:
receiving, by one or more processors, an anomaly signal from a sensor associated with the physical device, wherein the anomaly signal from the sensor indicates an operational anomaly to the physical device; and
in response to receiving the anomaly signal from the sensor associated with the physical device, generating, by one or more processors, an attack signal indicating that the physical device is being maliciously attacked.

13. The method of claim 1, wherein the physical device is a non-computing device.

14. The method of claim 1, wherein the physical device is a computing device.

15. A computer program storage device, the computer program storage device comprising a non-transitory computer readable storage medium having program code embodied therewith, the program code readable and executable by a processor to perform a method comprising:
receiving a notification of disparate anomalies experienced by each of multiple attack surfaces over an extended period of time, wherein the disparate anomalies are different types of anomalies compared to one another, and wherein the extended period of time exceeds a maximum threshold time period required to identify a high intensity attack against one or more of the multiple attack surfaces;
generating a synthetic event that includes all of the disparate anomalies experienced by the multiple attack surfaces;
receiving a notification that at least one particular attack surface is experiencing a predefined quantity of the disparate anomalies found in the synthetic event; and
in response to receiving the notification that the at least one particular attack surface is experiencing the predefined quantity of the disparate anomalies found in the synthetic event, generating an alert that a malicious attack is being attempted against one or more of the multiple attack surfaces.

16. The computer program storage device of claim 15, wherein the method further comprises:
collecting the disparate anomalies from disparate physical locations; and
in response to the collected disparate anomalies from the disparate physical locations exceeding a predetermined level, generating the synthetic event.

17. A computer system comprising:
a processor, a computer readable memory, and a non-transitory computer readable storage medium;
first program instructions to receive a notification of disparate anomalies experienced by each of multiple attack surfaces over an extended period of time, wherein the disparate anomalies are different types of anomalies compared to one another, and wherein the extended period of time exceeds a maximum threshold time period required to identify a high intensity attack against one or more of the multiple attack surfaces;
second program instructions to generate a synthetic event that includes all of the disparate anomalies experienced by the multiple attack surfaces;
third program instructions to receive a notification that at least one particular attack surface is experiencing a predefined quantity of the disparate anomalies found in the synthetic event; and
fourth program instructions to, in response to receiving the notification that the at least one particular attack surface is experiencing the predefined quantity of the disparate anomalies found in the synthetic event, generate an alert that a malicious attack is being attempted against one or more of the multiple attack surfaces; and wherein
the first, second, third, and fourth program instructions are stored on the non-transitory computer readable storage medium for execution by one or more processors via the computer readable memory.

18. The computer system of claim 17, further comprising:
fifth program instructions to collect the disparate anomalies from disparate physical locations; and
sixth program instructions to, in response to the collected disparate anomalies from the disparate physical locations exceeding a predetermined level, generate the synthetic event; and
wherein
the fifth and sixth program instructions are stored on the non-transitory computer readable storage medium for execution by one or more processors via the computer readable memory.

19. The computer system of claim 17, further comprising:
fifth program instructions to receive a notification that at least one of the disparate anomalies found in the synthetic event contains a known malicious feature; and
sixth program instructions to, in response to receiving the notification that at least one of the disparate anomalies found in the synthetic event contains the known malicious feature, issue a warning that all of the disparate anomalies found in the synthetic event are suspected malicious attacks; and wherein
the fifth and sixth program instructions are stored on the non-transitory computer readable storage medium for execution by one or more processors via the computer readable memory.

20. The computer system of claim 17, wherein all of the disparate anomalies were attempted misuses of the multiple attack surfaces, and wherein all of the attempted misuses were prevented by security systems on the multiple attack surfaces, and wherein the computer system further comprises:
fifth program instructions to append an explanation to the synthetic event describing what prompted the security systems to prevent the attempted misuses; and wherein the fifth program instructions are stored on the non-transitory computer readable storage medium for execution by one or more processors via the computer readable memory.
